(19) United States
(12) Patent Application Publication
(10) Pub. No.: US 2008/0002400 A1
(43) Pub. Date: Jan. 3, 2008

(54) ILLUMINATING RING

(75) Inventor: Jack HUANG, Tucheng City (TW)

Correspondence Address: PATENTTM.US, P. O. BOX 82788, PORTLAND, OR, 97282-0788, US

(73) Assignee: YUJING TECHNOLOGY CO., LTD., Tucheng City (TW)

(21) Appl. No.: 11/427,258

(22) Filed: Jun. 28, 2006

(51) Int. Cl. F21V 7/10

(52) U.S. Cl. 362/216

(57) ABSTRACT

A illuminating ring includes an annular body with an arcuate front face, a flat rear face and having multiple grooves defined in the flat rear face and an illuminating element mounted on the flat rear face to illuminate the annular body such that the annular body is able to substantially glow evenly due to groove arrangement in the annular body.

### BACKGROUND OF THE INVENTION

1. Field of the Invention

The present invention relates to an illuminating ring, and more particularly to an illuminating ring made of a transparent material and having therein a recessed area to receive therein an illuminating element and multiple grooves defined in a side face of the illuminating ring. A density of the grooves is inverse proportional to a position where the illuminating element is located. That is, closer to the illuminating element, the density of the grooves is smaller. On the contrary, farther to the illuminating element, the density of the grooves is larger such that the illuminating effect of the illuminating ring is bright and even.

2. Description of the Prior Art

A conventional illuminating ring (30) is shown in FIGS. 6 and 7 and includes a front side (31), an atomized rear side (32), a recessed area (33) defined in the atomized rear side (32) to receive therein an illuminating element (34).

After the conventional illuminating ring (30) is mounted on an automobile tail light, a front light or even a surface, activation of the illuminating element (34) allows the light to be dispersed along the illuminating ring (30).

With reference to FIG. 8, it is noted that farther away from the illuminating element (34), the light emitted from the illuminating ring (30) is weaker, which causes unbalanced illumination

To overcome the shortcomings, the present invention tends to provide an improved illuminating ring to mitigate the aforementioned problems.

### SUMMARY OF THE INVENTION

The primary objective of the present invention is to provide an improved illuminating ring having therein multiple grooves defined in a side face of the illuminating ring. A density of the grooves is inverse proportional to a distance to the illuminating element. That is, a gap between two adjacent grooves close to the illuminating element is larger than a gap between two adjacent grooves away from the illuminating element. Thus an even illumination effect is reached.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the illuminating ring of the present invention;

FIG. 2 is an exploded perspective view of the illuminating ring of the present invention;

FIG. 3 is a partially cross-sectional view of the illuminating ring in FIG. 1;

FIG. 4 is an operational view showing that the illumination of the illuminating ring of the present invention is even;

FIG. 5 is a perspective view of a different embodiment of the present invention;

FIG. 6 is an exploded perspective view of a conventional illuminating ring;

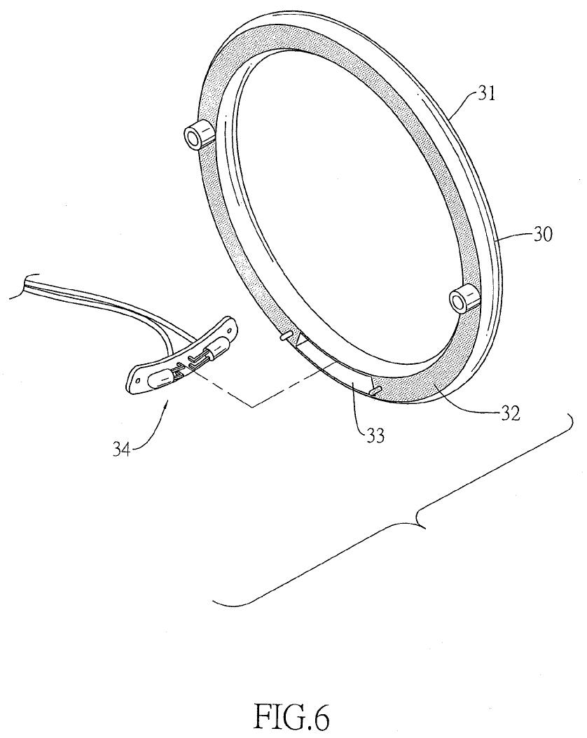

FIG. 7 is a partially cross-sectional view of the conventional illuminating ring of the present invention; and

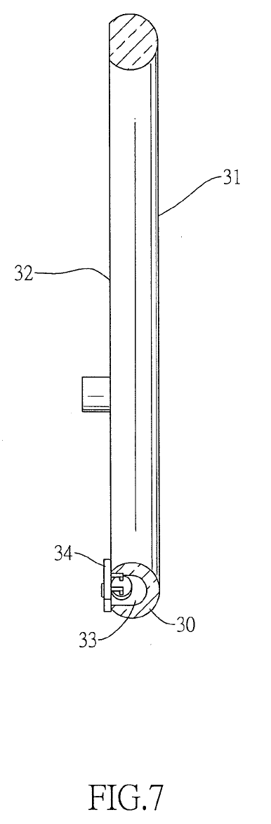

FIG. 8 is an operational view showing the illumination of the illuminating ring of FIG. 6.

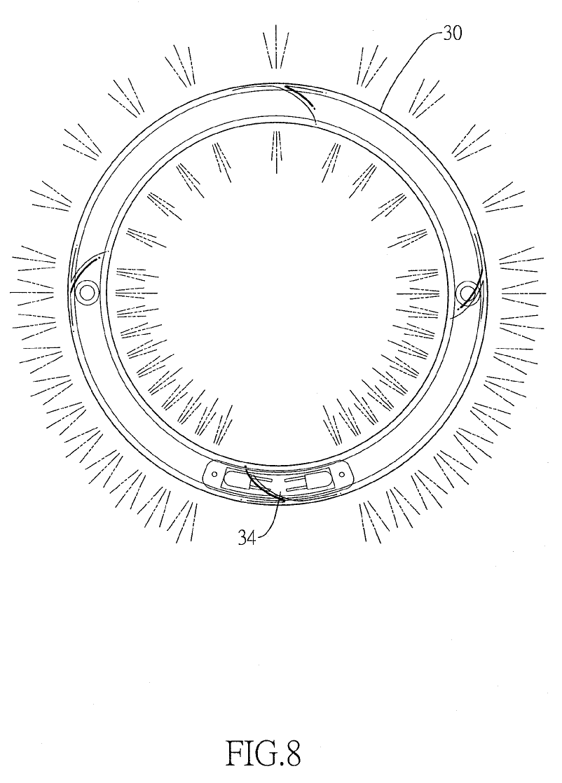

### DETAILED DESCRIPTION OF THE PREFERRED EMBODIMENT

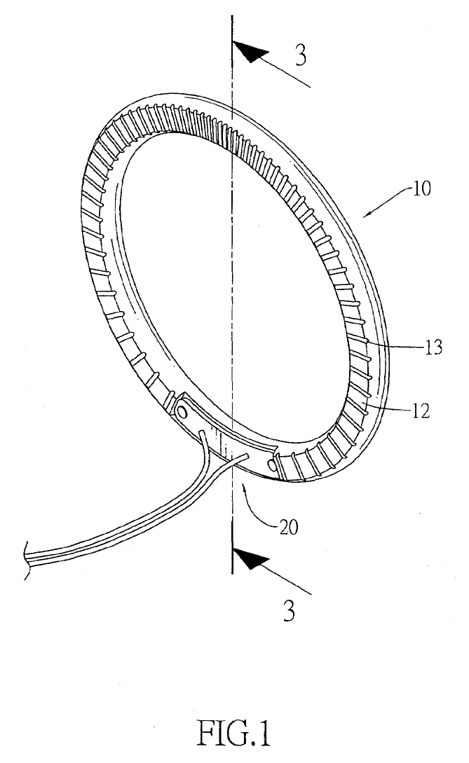

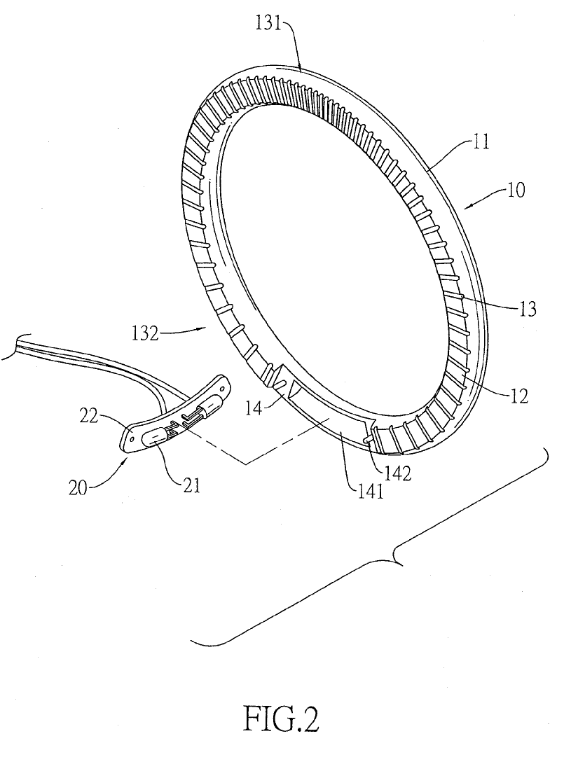

With reference to FIGS. 1 and 2, it is noted that the illuminating ring (10) in accordance with the present invention includes an annular body having an arcuate front side (11), a flat rear side (12), multiple grooves (13) defined in the flat rear side (12) and a mounting area (14) defined to receive therein an illuminating element (20).

The mounting area (14) is composed of a recessed area (141) and two opposite connection rods (142) respectively formed on two ends of the mounting area (14). The illuminating element (20) includes at least one (two are shown) light emitting diode (LED) (21) and a circuit board (22) having the LED (21) mounted thereon.

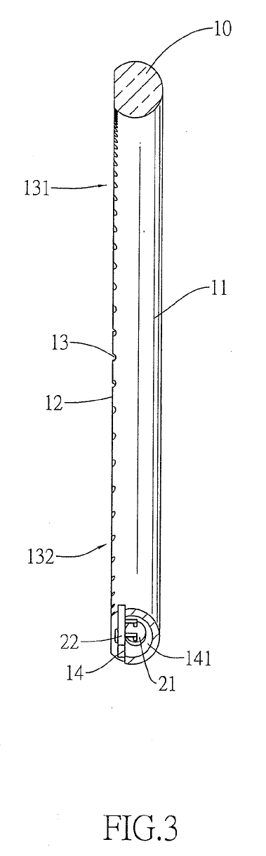

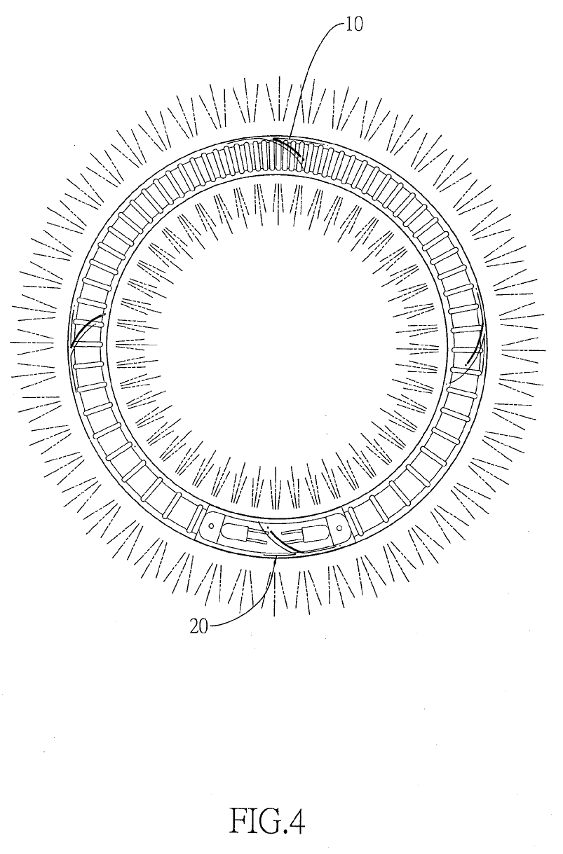

With reference to FIGS. 2 and 3, it is noted that a density of the grooves (13) is inverse proportional to a distance to the illuminating element (20). That is, a gap between two adjacent grooves (13) close to the illuminating element (20) is larger than a gap between two adjacent grooves (13) away from the illuminating element (20). Therefore, a dense area (131) is formed away from the illuminating element (20) and a sparse area (132) is formed close to the illuminating element (20) such that an even illumination effect, as shown in FIG. 4, is created resulted from the fact that the light reflection effect is dense in the dense area (131) away from the illuminating element (20) and light reflection effect is little in the sparse area (132) close to the illuminating element (20).

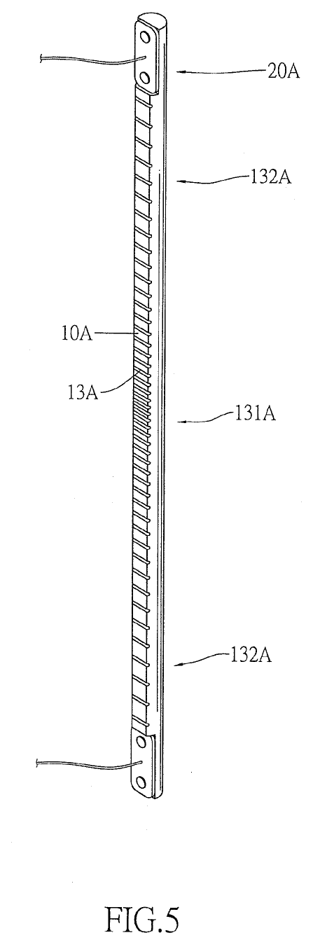

With reference to FIG. 5, a different embodiment of the illuminating ring (10A) is formed, wherein the illuminating ring (10A) has a cut in the sparse area (132A) so that the sparse area (132A) is separated into two halves. Each sparse area (132A) is provided with an illuminating element (20A) and the dense area (131) is between the two sparse area (132A).

In conclusion, it is noted that with the provision of the dense area (131,131A) and the sparse area (132,132A), the light from the illuminating element (20,20A) is able to be evenly transmitted to each part of the illuminating ring (10,10A) to allow the illuminating ring (10,10A) to substantially glow evenly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An illuminating ring comprising:
an annular body with an arcuate front face, a flat rear face and having multiple grooves defined in the flat rear face; and
an illuminating element mounted on the flat rear face to illuminate the annular body such that the annular body is able to substantially glow evenly due to groove arrangement in the annular body.

2. The illuminating ring as claimed in claim 1, wherein the groove arrangement is inverse proportional to a distance of a groove to the illuminating element.

3. The illuminating ring as claimed in claim 2, wherein the groove arrangement is density of the grooves.

4. The illuminating ring as claimed in claim 3, wherein the density of the grooves is inverse proportional to a distance to the illuminating element.

5. The illuminating ring as claimed in claim 4, wherein a gap between two adjacent grooves close to the illuminating element is larger than a gap between two adjacent grooves away from the illuminating element.
